(19) United States
(12) Patent Application Publication
(10) Pub. No.: US 2003/0119463 A1
(43) Pub. Date: Jun. 26, 2003

(54) Apparatus and method for maintaining linearity of an RF receiver in a mobile communication system

(75) Inventor: Hyoung-Kill Lim, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/314,749

(22) Filed: Dec. 9, 2002

(30) Foreign Application Priority Data
Dec. 7, 2001 (KR) 77506/2001

(51) Int. Cl. H04B 1/06; H04B 7/00

(52) U.S. Cl. 455/245.1; 455/234.1

(57) ABSTRACT

An apparatus for maintaining linearity of an RF (Radio Frequency) receiver in a mobile communication system. The RF receiver includes an antenna for receiving an RF signal, an amplifier for amplifying the RF signal, a mixer connected to the amplifier, for converting the RF signal to an IF (Intermediate Frequency) signal, and an AGC (Automatic Gain Controller) for converting the power level of the IF signal received from the mixer to be within a predetermined range. To maintain linearity, a switch connected to the antenna and the amplifier switches the RF signal received from the antenna to the amplifier or switches the RF signal to bypass the amplifier, under control of the AGC, which controls the switch to perform the bypass when the power level of the RF signal exceeds a predetermined threshold.

### PRIORITY

This application claims priority to an application entitled “Apparatus and Method for Maintaining Linearity of RF Receiver in a Mobile Communication System” filed in the Korean Industrial Property Office on Dec. 7, 2001 and assigned Serial No. 2001-77506, the contents of which are hereby incorporated by reference.

### BACKGROUND OF THE INVENTION

1. Field of the Invention

The present invention relates generally to an apparatus and method for processing an RF (Radio Frequency) signal at a receiver of a base station in a mobile communication system, and in particular, to a signal processing apparatus and method for ensuring the linearity of a received signal.

2. Description of the Related Art

In a mobile communication system, a base station generally includes an RF receiver.

FIG. 1 illustrates an RF receiver of a base station in a mobile communication system. Referring to FIG. 1, the RF receiver converts the frequency of a signal received through an antenna 100 and interfaces with a digital circuit. The power of the received signal has a great variance of about 60 dB. The RF receiver converts the signal having highly variable power to a baseband signal and feeds the baseband signal to the digital block. An AGC (Automatic Gain Controller) 50 converts the signal having a highly variable power to a signal having power within a predetermined range. A RF receiver in each base station includes an AGC 50 to maintain the power of a received signal within a predetermined range. Meanwhile, linearity must be maintained for stable system operation.

FIG. 2 is a graph illustrating a relationship between an input signal and an output signal in a system having ideal linear characteristics. A typical system does not have such ideal linearity due to saturation.

FIG. 3 is a graph illustrating linear characteristics of a system under actual implementation circumstances. In this system, linearity is not ensured due to saturation when the power of an input signal exceeds a predetermined level.

As illustrated in FIG. 3, a typical system experiences linearity deterioration when a level of an input signal exceeds a predetermined level. As a result, an output signal from the system is distorted and an unintended signal may be generated. Therefore, maintenance of system linearity is significant to stable operation of the system and performance improvement.

When the power of a signal received through the antenna 100 is relatively high, the linearity of the base station is deteriorated as is illustrated in FIG. 3. In order to maintain the linearity of the RF receiver, its components must have excellent characteristics and a sufficient margin must be secured in block designing. As a result, product cost increases.

### SUMMARY OF THE INVENTION

It is, therefore, an object of the present invention to provide an apparatus and method for maintaining the linearity of an RF receiver of a base station in a mobile communication system.

It is another object of the present invention to provide an apparatus and method of maintaining the linearity of an RF receiver with reduced cost in a base station.

To achieve the above and other objects, there is provided an apparatus for maintaining linearity of an RF (Radio Frequency) receiver in a mobile communication system. The RF receiver has an antenna for receiving an RF signal, an amplifier for amplifying the RF signal, a mixer connected to the amplifier, for converting the RF signal to an IF (Intermediate Frequency) signal, and an AGC (Automatic Gain Controller) for converting the power level of a signal received from the mixer within a predetermined range. To maintain the linearity, a switch connected to the antenna and the amplifier switches the RF signal received from the antenna to the amplifier, or switches the RF signal to bypass the amplifier. The AGC controls the switch to perform the bypass when the power level of the RF signal exceeds a predetermined value.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates an RF receiver of a base station in a mobile communication system;

FIG. 2 is a graph illustrating a relationship between an input signal and an output signal in a system having ideal linear characteristics;

FIG. 3 is a graph illustrating linear characteristics of a system under real implementation circumstances, in which linearity is not ensured due to saturation when the power of an input signal exceeds a predetermined level; and

FIG. 4 illustrates an RF receiver including a switch for switching an input signal to bypass an amplifier without amplification when the power of the input exceeds a predetermined level according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

An RF switch is required to realize an RF receiver according to the present invention.

As described above, one cause of linear deterioration at a receiver is saturation observed in a component such as an amplifier or a mixer, due to a higher power level of an input signal. The saturation is a point beyond which a measurement is not expected to increase. At a saturation point, an input signal and an output signal are not in a proportional relation.

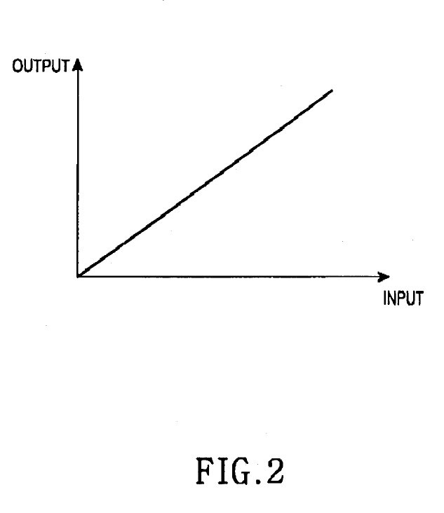

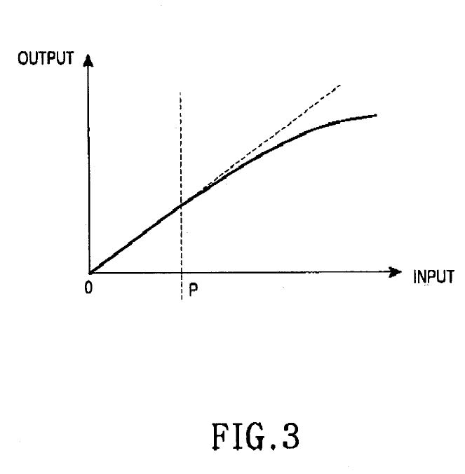

Referring to FIG. 3, when a power of an input signal is higher than P, the system reaches saturation. At a non-saturating power level, the system exhibiting non-linearity on the whole assumes linear characteristics like the ideal system having the linear characteristics illustrated in FIG. 2. In FIG. 3, linearity is achieved at power levels 0 to P. This implies that if the power of an input signal is maintained below P, the system can maintain its linearity.

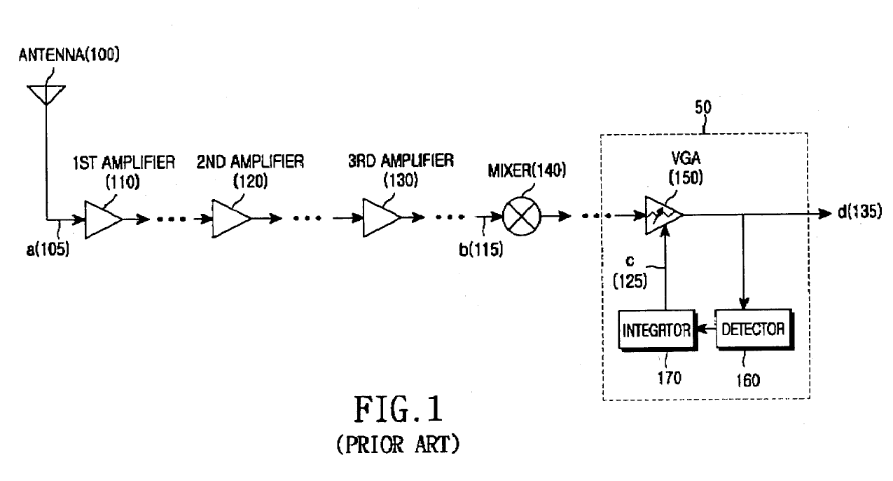

To apply the same concept to a base station in a mobile communication system referring to FIG. 1, a RF signal received through the antenna 100 is amplified in three stages by amplifiers 110, 120, and 130 and fed to a mixer 140. The mixer 140 connected to the amplifiers converts the amplified RF signal to an IF (Intermediate Frequency) signal. The output of the mixer 140 is fed back to a VGA (Variable Gain Amplifier) 150 through a detector 160 and an integrator 170. The detector 160 detects the power level of a signal received from the VGA 150. The output of the integrator 170 is fed to the VGA 150 as a control signal for controlling an amplification rate. The VGA 150, the detector 160, and the integrator 170 collectively form the AGC 50.

An input signal to a base station in a typical CDMA (Code Division Multiple Access) mobile communication system has a power level between −110 dB and −60 dB. When a signal having low power is input to the RF receiver, there are no problems. On the other hand, when a signal having high power is input, the power level is increased due to the gains of the amplifiers in the RF receiver. The main cause of linear deterioration at the RF receiver is that a high power level of an input signal saturates components, such as the amplifiers 110, 120, and 130, and the mixer 140. It is to be noted here that the description of the present invention is made in the context of a CDMA mobile communication system. When a signal having low power is input, no saturation is observed in each component and the RF receiver remains linear. Even after power amplification in the amplifiers 110, 120, and 130, the low-power signal does not reach a power level that leads to saturation and cause linear deterioration. However, a signal having a power high enough to saturate the components of the RF receiver and deteriorate the linearity of the RF receiver may be input to the RF receiver. Alternatively, some input signals may reach power levels that cause linear deterioration after being amplified in the amplifiers 110, 120, and 130 by their gains. In other words, controlling the input signals to prevent them from reaching power levels, which cause linear deterioration, maintains the linearity of the RF receiver.

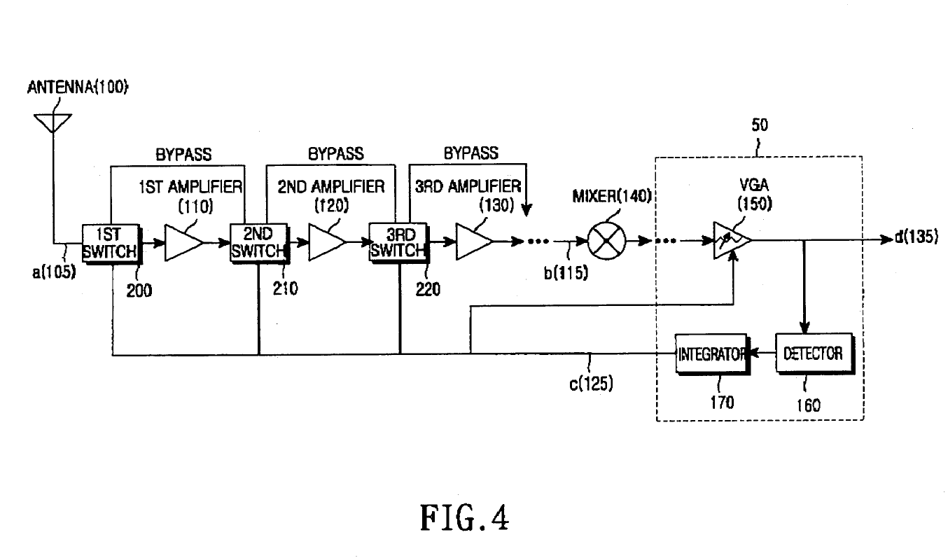

FIG. 4 illustrates an RF receiver including a switch for switching an input signal to bypass an amplifier when the power of the input signal exceeds a predetermined level according to the present invention. Referring to FIG. 4, to prevent linear deterioration, an input signal bypasses the amplifiers 110, 120, and 130 according to the level of the input signal. When a low-power signal is received, the amplifiers 110, 120 and 130 are normally operated. When a high-power level signal is received, it bypasses the amplifiers 110, 120, and 130 to avoid amplification. The bypass operation is performed by switches 200, 210, and 220, included at the front ends of the amplifiers 110, 120, and 130. As a result, the power of the input signal is maintained at an appropriate level until it reaches the mixer 140 and the AGC 50. As a result, no saturation occurs.

The switches 200, 210, and 220 are controlled by control signals output from the AGC 50. In order to feed a signal at a predetermined power level to the digital block, the RF receiver detects the power level of an input signal and uses the detection result as a control voltage for a VGA 150. This operation is performed in the AGC 50. That is, since the AGC 50 detects the power level of an input signal, it can control the switches 200, 210, and 220 with the AGC control voltages. Aside from the conventional power control function, the AGC 50 detects the power level of an input signal, compares it with a reference value set for maintaining linearity, and outputs control signals to the switches 200, 210, and 220 according to the present invention. When the power level of an input signal is higher than the reference value, the AGC 50 activates the switches 200, 210, and 220, thereby bypassing the amplifiers 110, 120, and 130, respectively. If the power level is equal to or less than the reference value, the AGC 50 deactivates the switches 200, 210, and 220, and the RF signals are sent to the amplifiers 110, 120, and 130. The reference value can be obtained empirically.

A reason for adding switches 200, 210, and 220 to the amplifiers 110, 120 and 130 is that the linearity of the RF receiver is determined by each of its components. That is, saturation in any of the amplifiers 110, 120, and 130 causes linear deterioration.

In accordance with the present invention, even though a signal having a power level high enough to deteriorate system linearity is received, the linearity of the RF receiver can be maintained. Activating the amplifiers in the RF receiver only when amplification is required according to the power level of an input signal reduces system power consumption. As a result, despite using lower grade components, i.e., components not having characteristics as good as conventional components, linearity is maintained, and system cost is reduced.

While the invention has been shown and described with reference to a preferred embodiment thereof, in which an RF receiver has three amplifiers and the power level of an input signal is limited to −110 dB to −60 dB, it will be understood by those skilled in the art that various changes in form and details may be made therein without departing from the spirit and scope of the invention as defined by the appended claims.

What is claimed is:

1. An apparatus for maintaining linearity of an RF (Radio Frequency) receiver including an antenna for receiving an RF signal, at least one amplifier for amplifying the RF signal, a mixer connected to the at least one amplifier, for converting the RF signal to an IF (Intermediate Frequency) signal, and an AGC (Automatic Gain Controller) for converting a power level of the IF signal received from the mixer to be within a predetermined range in a mobile communication system, the apparatus comprising:
at least one switch connected between the antenna and the at least one amplifier, for switching the RF signal received from the antenna to the amplifier and switching the RF signal to bypass the amplifier; and
the AGC, which controls the switch to bypass the at least one amplifier when a power level of the RF signal exceeds a predetermined threshold.

2. The apparatus of claim 1, wherein the AGC comprises:
a VGA (Variable Gain Amplifier) for changing an amplification rate of the RF signal;
a detector for detecting the power level of a signal received from the VGA; and
an integrator for converting a signal received from the detector to a control signal for determining an amplification rate of the VGA.

3. The apparatus of claim 1, wherein the predetermined value is set to maintain the linearity of the RF receiver.

4. A method of maintaining linearity of an RF (Radio Frequency) receiver including an antenna for receiving an RF signal, an amplifier connected to the antenna through a switch that switches the RF signal to bypass the amplifier, a mixer connected to the amplifier and the switch, for converting the RF signal to an IF (Intermediate Frequency) signal, and an AGC (Automatic Gain Controller) for converting a power level of the IF signal received from the mixer within a predetermined range in a mobile communication system, the method comprising the steps of:
detecting a power level of the RF signal input to the AGC;
determining whether the detected power level exceeds a predetermined threshold; and
controlling the RF signal to bypass the amplifier, utilizing the switch, if the detected power level exceeds the predetermined threshold.
